(19) United States
(12) Patent Application Publication
(10) Pub. No.: US 2007/0288577 A1
(43) Pub. Date: Dec. 13, 2007

(54) Email with an Answer-Required Field

(76) Inventors: Curtis Duane Kronlund, Cottage Grove, MN (US); Scott Alan Moore, Rochester, MN (US); Gregory Allan Olson, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/423,625

(22) Filed: Jun. 12, 2006

(51) Int. Cl. G06F 15/16

(52) U.S. Cl. 709/206

(57) ABSTRACT

In an embodiment, a send command is received that specifies a reply email, which is a reply to a source email. If the source email includes an answer-required field associated with a question, a determination is made whether the reply email includes an answer associated with the answer-required field. If the reply email includes the answer, then the reply email is sent to a source of the source email, but if the reply email does not include the answer, the reply email is blocked from being sent. In an embodiment, the source email is embedded in the reply email as a replied-to email, the source email includes reply data that is separate from the replied-to email, and the reply data includes the answer and a pointer that identifies the answer-required field. In another embodiment, the answer is embedded in the answer-required field in the replied-to email. In this way, answers may be required to email questions.

### FIELD

An embodiment of the invention generally relates to email (electronic-mail). In particular, an embodiment of the invention generally relates to requiring answers to questions in email.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware components (such as semiconductors, integrated circuits, programmable logic devices, programmable gate arrays, power supplies, electronic card assemblies, sheet metal, cables, and connectors) and software, also known as computer programs.

Years ago, computers were isolated devices that did not communicate with each other. But, today computers are often connected in networks. One such network is the Internet or World Wide Web, in which electronic document transfer and message communication such as electronic mail (email) are commonplace. Users of email are typically provided with a user email address, which serves as an electronic mail box. A user is able to create an email and transmit it to one or more other users via their respective user email address. A user email address is not necessarily associated with a particular computer, so a user may send and retrieve email via the user email address from a variety of computers

More and more users globally are communicating via email, which is often less expensive and/or more convenient than face-to-face meetings, telephone calls, faxes, or letters, for both the sender and the recipient. The sender can write the email at a time and place of the sender's convenience and send the email to the email address of the recipient, regardless of the current location or availability of the recipient. The electronic mailbox of the recipient typically receives the email quickly (e.g., within a few seconds, minutes, or hours), and the recipient can retrieve the email and respond, if necessary, at a time and place of the recipient's convenience.

While both the sender and recipient acting at times of their own convenience can be advantageous, problems can also result for the lack of immediate interaction. For example, senders often ask questions via email, but the recipients might respond to some, but not all, of the questions in a reply email. Recipients might omit an answer for a variety of reasons: they do not know the answer, the email contains many questions and they inadvertently overlook one, they intend to answer the question later after additional investigation or after receiving information from others, they think the question is someone else's responsibility, or they have other priorities that they view as more important. Since the original sender of the emailed question does not know the reason for the lack of an answer, the original sender might send another email that re-asks the question and wait for another reply email. These extra emails slow down the information-exchange process and reduce the advantages of email as a communication technique.

What is needed is a better technique for managing the asking and answering of questions via email.

### SUMMARY

A method, apparatus, system, and signal-bearing medium are provided. In an embodiment, a send command is received that specifies a reply email, which is a reply to a source email. If the source email includes an answer-required field associated with a question, a determination is made whether the reply email includes an answer associated with the answer-required field. If the reply email includes the answer, then the reply email is sent to a source of the source email, but if the reply email does not include the answer, the reply email is blocked from being sent. In an embodiment, the source email is embedded in the reply email as a replied-to email, the source email includes reply data that is separate from the replied-to email, and the reply data includes the answer and a pointer that identifies the answer-required field. In another embodiment, the answer is embedded in the answer-required field in the replied-to email. If the answer indicates that the question will be answered after the sending of the reply email, an identifier of the source email is saved and a reminder is presented if an elapsed time since the sent time of the reply email exceeds a threshold. In this way, answers may be required to email questions.

### BRIEF DESCRIPTION OF THE DRAWINGS

FIG. 1 depicts a block diagram of an example system for implementing an embodiment of the invention.

FIG. 2 depicts a block diagram of an example source email, according to an embodiment of the invention.

FIG. 3 depicts a block diagram of an example reply email, according to an embodiment of the invention.

FIG. 4 depicts a block diagram of an example reply email, according to an embodiment of the invention.

FIG. 5 depicts a block diagram of an example to-do list, according to an embodiment of the invention.

FIG. 6 depicts a flowchart of example processing for adding a answer-required field to a source email, according to an embodiment of the invention.

FIG. 7 depicts a flowchart of example processing for adding a answer-required field to source email, according to an embodiment of the invention.

FIG. 8 depicts a flowchart of example processing for a reply command, according to an embodiment of the invention.

FIG. 9 depicts a flowchart of example processing for displaying records from a to-do list, according to an embodiment of the invention.

### DETAILED DESCRIPTION

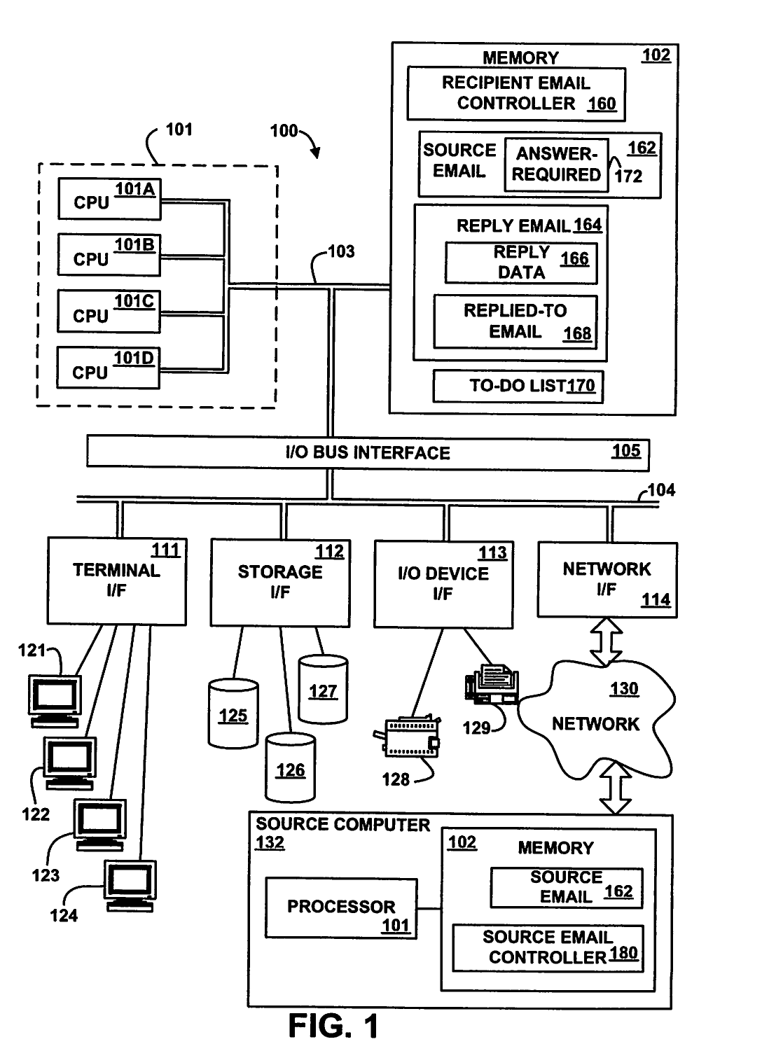

Referring to the Drawings, wherein like numbers denote like parts throughout the several views, FIG. 1 depicts a high-level block diagram representation of a recipient computer system 100 connected via a network 130 to a source computer system 132, according to an embodiment of the present invention. The terms “source” and “recipient” are used herein for convenience only, and an electronic device that acts as a source computer of an email in one embodiment may act as a recipient computer of the same or of a different email in another embodiment, and vice versa. In an embodiment, the hardware components of the recipient computer system 100 may be implemented by an eServer iSeries computer system available from International Business Machines of Armonk, New York. However, those skilled in the art will appreciate that the mechanisms and apparatus of embodiments of the present invention apply equally to any appropriate computing system.

The major components of the recipient computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The recipient computer system 100 contains one or more general-purpose programmable central processing units (CPUs) 101A, 101B, 101C, and 101D, herein generically referred to as the processor 101. In an embodiment, the recipient computer system 100 contains multiple processors typical of a relatively large system; however, in another embodiment the recipient computer system 100 may alternatively be a single CPU system. Each processor 101 executes instructions stored in the main memory 102 and may include one or more levels of on-board cache.

The main memory 102 is a random-access semiconductor memory for storing data and programs. In another embodiment, the main memory 102 represents the entire virtual memory of the recipient computer system 100, and may also include the virtual memory of other computer systems coupled to the recipient computer system 100 or connected via the network 130. The main memory 102 is conceptually a single monolithic entity, but in other embodiments the main memory 102 is a more complex arrangement, such as a hierarchy of caches and other memory devices. For example, the main memory 102 may exist in multiple levels of caches, and these caches may be further divided by function, so that one cache holds instructions while another holds non-instruction data, which is used by the processor or processors. The main memory 102 may be further distributed and associated with different CPUs or sets of CPUs, as is known in any of various so-called non-uniform memory access (NUMA) computer architectures.

The memory 102 includes or stores a recipient email controller 160, a source mail 162, a reply email 164, and a to-do list 170. Although the recipient email controller 160, the source mail 162, the reply email 164, and the to-do list 170 are illustrated as being stored within the memory 102 in the recipient computer system 100, in other embodiments some or all of them may be on different computer systems and may be accessed remotely, e.g., via the network 130. The recipient computer system 100 may use virtual addressing mechanisms that allow the programs of the recipient computer system 100 to behave as if they only have access to a large, single storage entity instead of access to multiple, smaller storage entities. Thus, while the recipient email controller 160, the source mail 162, the reply email 164, and the to-do list 170 are illustrated as being contained within the main memory 102, these elements are not necessarily all completely contained in the same storage device at the same time. Further, although the recipient email controller 160, the source mail 162, the reply email 164, and the to-do list 170 are illustrated as being separate entities, in other embodiments some of them, or portions of some of them, may be packaged together.

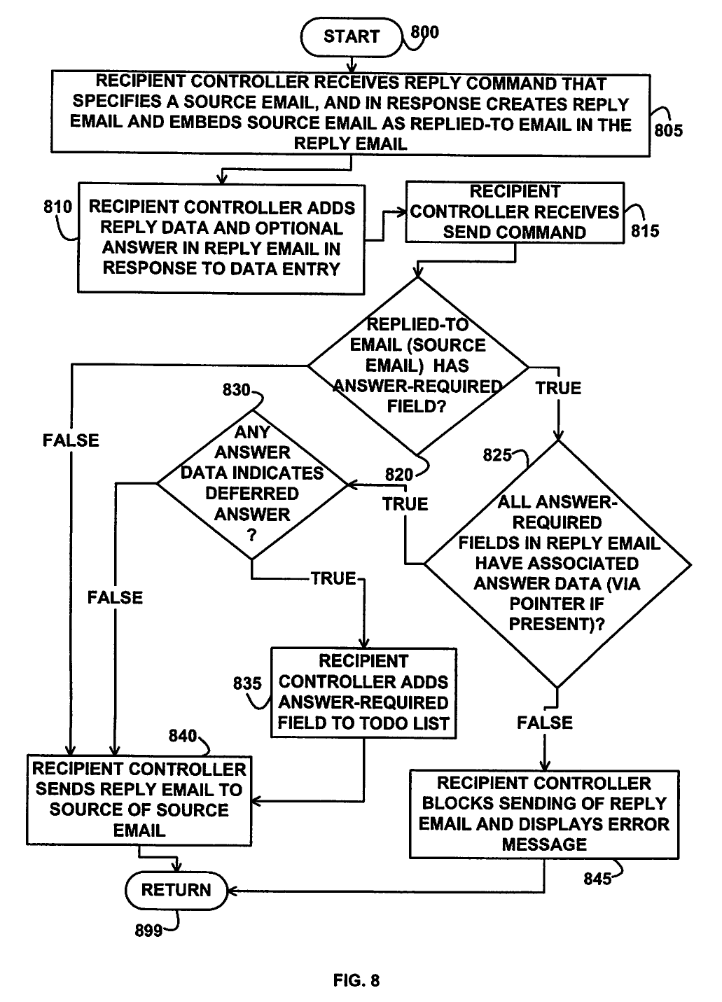

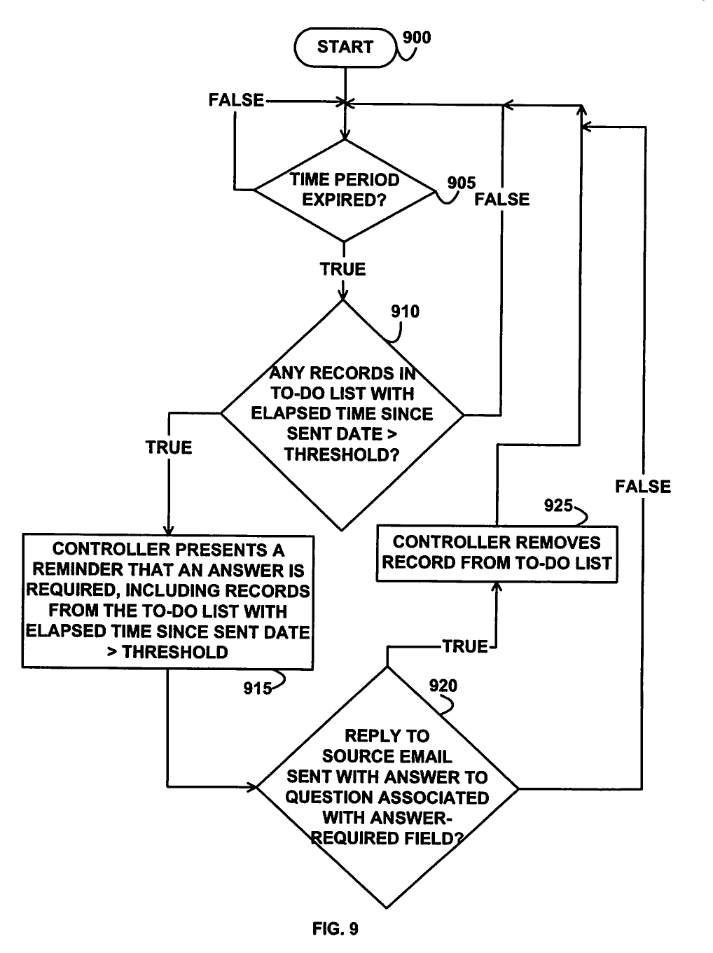

The recipient email controller 160 is an application that enables the sending and receiving of email, such as the source email 162 and the reply email 164. The recipient email controller 160 sends and receives the source email 162 and the reply email 164 via the network 130. In various embodiments, the recipient email controller 160 may be implemented as a web browser, mail client, or any other appropriate type of program. In various embodiments, the recipient email controller 160 may use POP3 (Post Office Protocol 3), IMAP (Internet Message Access Protocol), IMAP4 (Internet Message Access Protocol 4), SMTP (Simple Mail Transfer Protocol), or other any other appropriate protocol for sending and/or receiving the source email 162 and the reply email 164. The recipient email controller 160 includes instructions capable of executing on the processor 101 or statements capable of being interpreted by instructions executing on the processor 101 to perform the functions as further described below with reference to FIGS. 8 and 9. In another embodiment, the recipient email controller 160 may be implemented in microcode or firmware. In another embodiment, the recipient email controller 160 may be implemented in hardware via logic gates and/or other appropriate hardware techniques in lieu of or in addition to a processor-based system.

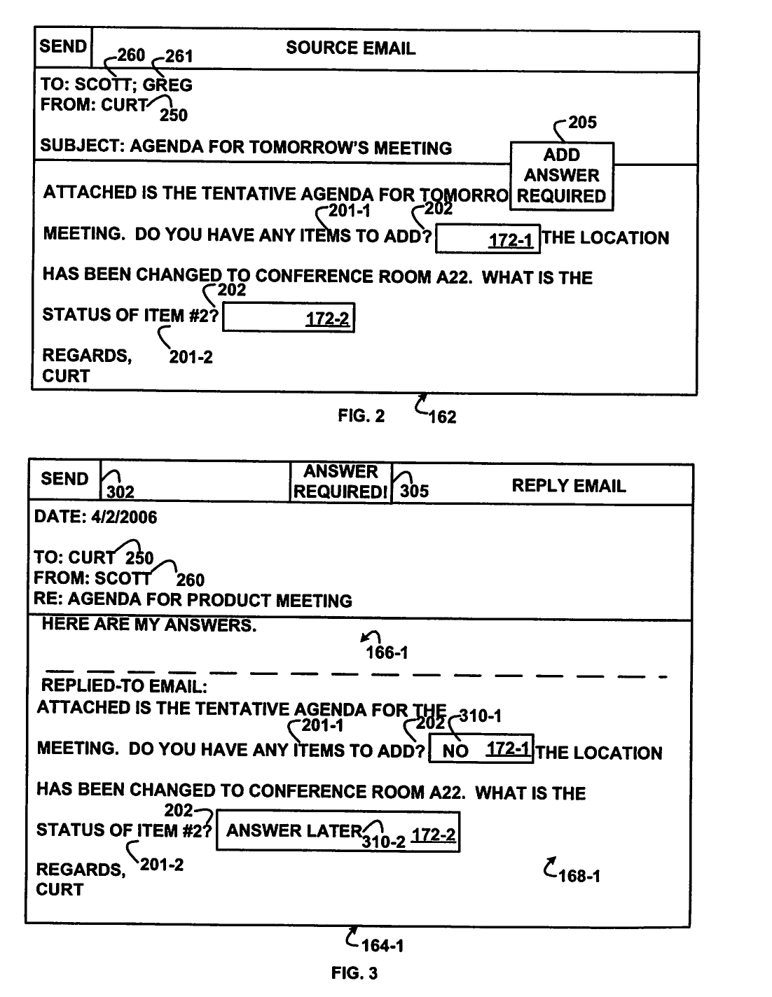

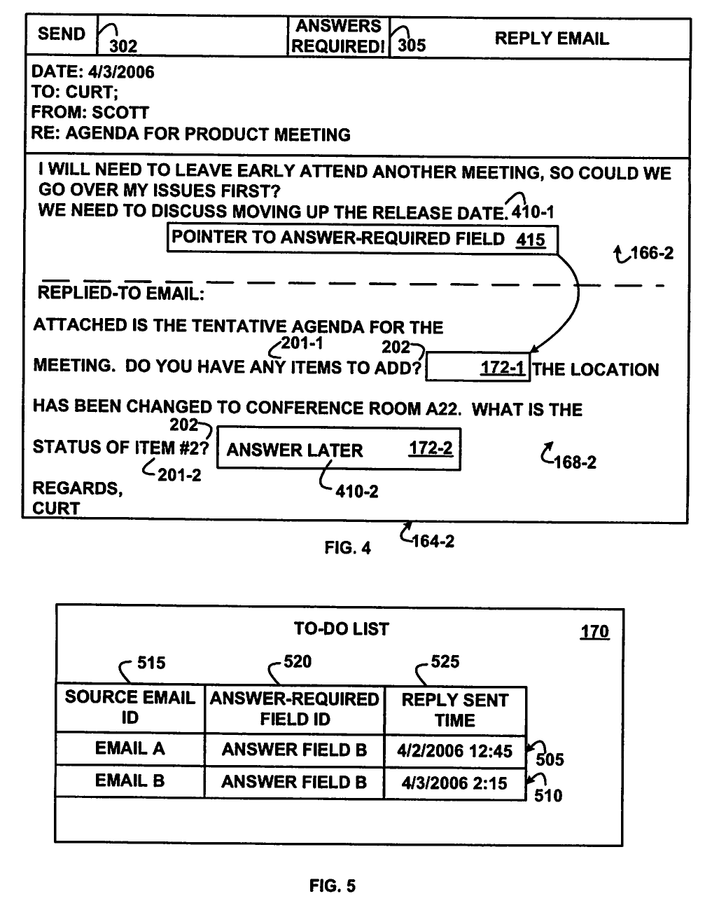

The source email 162 and the reply email 164 may include text messages, optional file attachments, graphics, or video, and are capable of being transmitted over the network 130 between the source computer system 132 and the recipient computer system 100 via the network 130. The terms “source” and “reply” as used herein are labels for convenience only, and an email that is a source email in one embodiment may be a reply email in another embodiment, and vice versa. The recipient computer system 100 received the source email 162 from the source computer system 132 and sends the reply email 164 to the source (the source email address 250) as a reply to the source email 162. The reply email 164 is then received at the source computer system 132 via the source email address 250. The source email 162 includes an optional answer-required field 172, which if present indicates that an answer to a question in the source email 162 is required in a reply email 164. An example of the source email 162 is further described below with reference to FIG. 2. The reply email 164 includes reply data 166 and a replied-to email 168, which is a copy of the source email 162 or a portion of the source email 162. Examples of the reply email 164 are further described below with reference to FIGS. 3 and 4.

The to-do list 170 includes information about source emails 162 that have questions that have not been answered. The to-do list 170 is further described below with reference to FIG. 5.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O and other device interface 113 provide an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the recipient computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the recipient computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The recipient computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The recipient computer system 100 may alternatively be a single-user system, typically containing only a single user display and keyboard input, or might be a server or similar device which has little or no direct user interface, but receives requests from other computer systems (clients). In other embodiments, the recipient computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the recipient computer system 100 and the source computer system 132. In various embodiments, the network 130 may represent a storage device or a combination of storage devices, either connected directly or indirectly to the recipient computer system 100 and the source computer system 132. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The network 130 may include a mail server and any number of intermediate servers that receive the source email 162 from the source computer system 132 and route the source email 162 to the recipient computer system 100, and that receive the reply email 164 from the recipient computer system 100 and route the reply email 164 to the source computer system 132. The mail server may also be known as a mail transfer agent (MTA) or a mail exchange server, and each of the source computer system 132 and the recipient computer system 100 may have its own or the same mail server. In an embodiment, the mail server may be implemented as part of an Internet Service Provider (ISP), but in other embodiments, the mail server may be implemented as any appropriate service that routes email between computers.

The source computer system 132 may include some or all of the hardware and/or software elements previously described above for the recipient computer system 100. Although the source computer system 132 is illustrated as being separate from the recipient computer system 100, in other embodiments some or all of the source computer system 132 and the recipient computer system 100 may be the same electronic device. The source computer system 132 includes a memory 102 connected to a processor 101 via a bus. The memory 102 in the source computer system 132 stores a source email 162 and a source email controller 180.

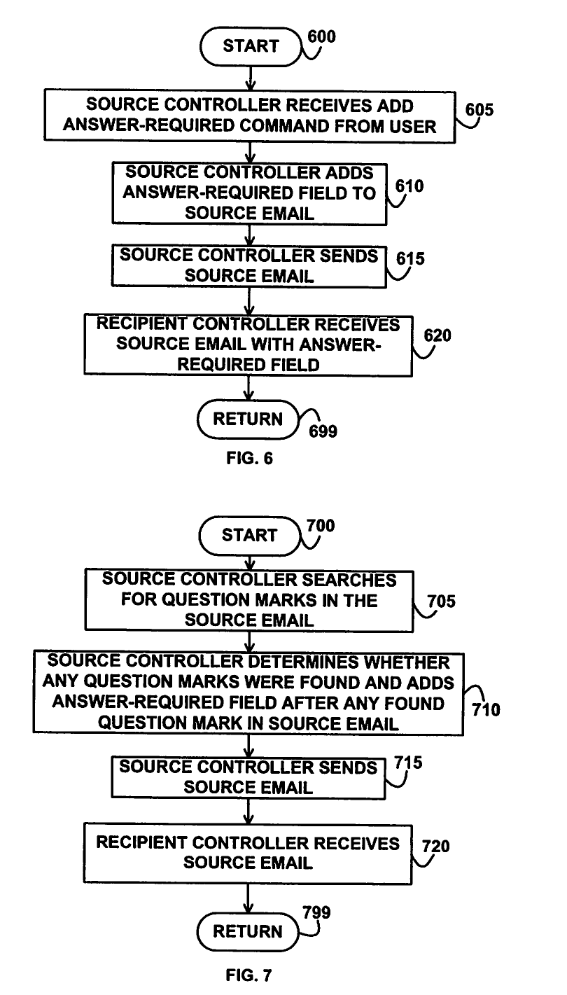

The source email controller 180 includes instructions capable of executing on the processor 101 or statements capable of being interpreted by instructions executing on the processor 101 to perform the functions as further described below with reference to FIGS. 6 and 7. In another embodiment, the source email controller 180 may be implemented in microcode or firmware. In another embodiment, the source email controller 180 may be implemented in hardware via logic gates and/or other appropriate hardware techniques in lieu of or in addition to a processor-based system.

Email typically includes a body and a header. Email may also include other components, such as an envelope that is ordinarily not viewed by users; instead, the envelope is used internally by the mail server to route the email. The body is the message or content of the email. The header is generated by the source email controller 180 that first sends the email and by all mail servers in the network 130, in route to the recipient email controller 160 at the recipient computer. Each mail server and email controller that sends, forwards, routes, or receives the email may add more information to the header. The header may include a variety of fields, such as: TO (specifying the intended recipient), FROM (specifying the sender), BCC (specifying recipients whose identity is not to be disclosed to other recipients), CC (carbon copy) SUBJECT, DATE, and any number of others. In an embodiment, the header includes key: value pairs that conform to RFC (Request for Comments) 822, but in other embodiments any appropriate standard, syntax, or protocol may be used.

Thus, the email that is received by the recipient is not necessarily exactly the same as the email that was sent by the source because information not normally viewed by users is added along the way. But, for the purposes of convenience of exposition, the source email 162 at the source computer system 132 and the source email 162 at the recipient computer system 100 are given the same name and reference numeral, so the source email 162 illustrated at the source computer system 132 and the source email 162 at the recipient computer system 100 represent the portion of electronic mail that is the same at both the source computer system 132 and the recipient computer system 100.

It should be understood that FIG. 1 is intended to depict the representative major components of the recipient computer system 100, the network 130, and the source computer system 132 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the recipient computer system 100 and/or the source computer system 132, and that, when read and executed by one or more processors 101 in the recipient computer system 100 and/or the source computer system 132, cause the recipient computer system 100 and/or the source computer system 132 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the recipient computer system 100 via a variety of tangible signal-bearing media that may be operatively or communicatively connected (directly or indirectly) to the processor 101. The signal-bearing media may include, but are not limited to the following computer-readable media:

(1) information permanently stored on a non-rewriteable storage medium, e.g., a read-only memory storage device attached to or within a computer system, such as a CD-ROM, DVD−R, or DVD+R;

(2) alterable information stored on a rewriteable storage medium, e.g., a hard disk drive (e.g., the DASD 125, 126, or 127), CD-RW, DVD−RW, DVD+RW, DVD-RAM, or diskette; or

(3) information conveyed by a communications or transmissions medium, such as through a computer or a telephone network, e.g., the network 130.

Such tangible signal-bearing media, when carrying or encoded with computer-readable, processor-readable, or machine-readable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a block diagram of a user interface for an example source email 162, according to an embodiment of the invention. The source email 162 includes an example source email address 250 and example recipient email addresses 260 and 261. The source email controller 180 at the source computer system 132 sends the source email 162 from the source email address 250 to the recipient email addresses 260 and 261.

The example source email 162 further includes questions 201-1 and 201-2, which are terminated by question mark characters 202. The source email 162 further includes an add answer-required command 205, in response to which the source email controller 180 adds the answer-required field 172-1 and/or the answer-required field 172-2 to the source email 162. In another embodiment, the source email controller 180 searches the source email 162 for the question marks 202 and adds the answer-required fields 172-1 and 172-2 in response to finding the question marks 202. In an embodiment, the source email controller 180 ignores question marks in combination with other characters that do not typically reflect a question that asks for or requires an answer, such as “!?” or “(?)”. In another embodiment, the recipient email controller 160 performs the search for the question marks 202 and adds the answer-required fields 172-1 and 172-2 in response to finding the question marks 202.

The source email controller 180 associates the answer-required field 172-1 and the answer-required field 172-2 with their respective questions 201-1 and 201-2 in the source email 162, e.g., by storing a pointer to the respective answer-required field 172 with the question or question mark, by storing a pointer to the respective question or question mark with the respective answer-required field 172, by storing an identifier of the question or question mark with the answer-required field 172, or by positioning the answer-required field 172 adjacent to the question mark 202 that terminates the respective question. Associating an answer-required field 172-1 or 172-2 with a respective question 201-1 or 201-2 means that the recipient controller 160 interprets the answer-required field 172-1 or 172-2 to require an answer associated with that answer-required field to that question if the recipient controller 160 sends a reply email 164 to the source (the source email address 250) that sent the source email 162 from the source computer system 132.

After the source email controller 180 at the source computer system 132 sends the source email 162 from the source email address 250 to the recipient email addresses 260 and 261, the recipient email controller 160 at the recipient computer 100 retrieves the source email 162 from the network 130 and presents the source email 162 in a user interface for the recipient email address 260.

FIG. 3 depicts a block diagram of a user interface for an example reply email 164-1, according to an embodiment of the invention. The reply email 164-1 is an example of the reply email 164 (FIG. 1). The recipient email controller 160 creates the reply email 164-1 to reply to the source email 162 in response to receiving a reply command from a user interface for the recipient email address 260 that identifies the source email 162 as the email for which a reply is to be sent (to the source email address 250 that sent the source email 162).

The reply email 164-1 includes reply data 166-1 and a replied-to email 168-1, which is separate from the reply data 166-1. The reply data 166-1 is an example of the reply data 166 (FIG. 1), and the replied-to email 168-1 is an example of the replied-to email 168 (FIG. 1). The recipient email controller 160 copies the source email 162 into the reply email 164-1 as the replied-to email 168-1. Thus, since the source email 162 includes the questions 201-1 and 201-2, the question marks 202, and the answer-required fields 172-1 and 172-2, the replied-to email 168-1 includes them as well. The recipient email controller 160 creates or adds the reply data 166-1 to the reply email 164-1 in response to data entry from a user interface for the recipient user email address.

The recipient email controller 160 embeds or adds the answers 310-1 and 310-2 to the replied-to email 168-1 in the answer-required fields 172-1 and 172-2, respectively, in response to data entry from a user at the recipient computer system 100 for the user recipient email address 260. The answer 310-1 answers the question 201-1 in the replied-to email 168-1 (and the source email 162). The answer 310-2 answers the question 201-2 in the replied-to email 168-1 and the source email 162. The answer 310-2 of “answer later” illustrates a deferred answer indication, meaning that that the user at the recipient email address 260 intends to supply an answer to the question 201-2 in another reply email that the user intends to send later to, or following, the reply email 164-1.

The answer-required field 172-1 is associated with the question 201-1 in the replied-to email 168-1, in that the presence of the answer-required field 172-1 means that an answer to the question 201-1 is required in the reply email 164-1. The answer-required field 172-2 is associated with the question 201-2 in the replied-to email 168-1, in that the presence of the answer-required field 172-2 means that an answer to the question 201-2 is required in the reply email 164-1.

In response to the send command 302, if the user has supplied the answers 310-1 and 310-2 for the answer-required fields 172-1 and 172-2, respectively, the recipient email controller 160 sends the reply email 164-1 to the source of the replied-to email 168-1 (the source email address 250 that sent the source email 162). If the user has not supplied the answers 310-1 and 310-2 in the answer-required fields 172-1 and 172-2, respectively, the recipient email controller 160 blocks the sending of the reply email 164-1 (does not send the reply email 164-1) and presents the answer required message 305 to indicate that answers must be supplied to the questions 201-1 and 201-2 in order to send the reply email 164-1.

FIG. 4 depicts a block diagram of a user interface for an example reply email 164-2, according to an embodiment of the invention. The reply email 164-2 is an example of the reply email 164 (FIG. 1). The recipient email controller 160 creates the reply email 164-2 to reply to the source email 162 in response to receiving a reply command from a user interface that identifies the source email 162 and requests creating a reply to the source email 162.

The reply email 164-2 includes reply data 166-2 and a replied-to email 168-2, which is separate from the reply data 166-2. The reply data 166-2 is an example of the reply data 166 (FIG. 1), and the replied-to email 168-2 is an example of the replied-to email 168 (FIG. 1). The recipient email controller 160 copies the source email 162 into the reply email 164-2 as the replied-to email 168-2, i.e., the recipient email controller 160 creates the replied-to email 168-2 as a copy of the source email 162. Thus, since the source email 162 includes the questions 201-1 and 201-2, the question marks 202, and the answer-required fields 172-1 and 172-2, the replied-to email 168-1 includes them as well. The recipient email controller 160 creates or adds the reply data 166-2 to the reply email 164-2 in response to data entry from a user interface, e.g., the terminals 121, 122, 123, or 124 (FIG. 1).

The reply data 166-2 includes the answer data 410-1 and a pointer 415 (associated with or connected to the answer data 410-1) that points to or identifies the answer-required field 172-1 in the replied-to email 168-2. The answer-required field 172-1 is associated with, or connected to, the question 201-1 in the replied-to email 168-2, in that the presence of the answer-required field 172-1 means that an answer to the question 201-1 is required in the reply email 164-2. The answer-required field 172-2 is associated with, or connected to, the question 201-2 in the replied-to email 168-2, in that the presence of the answer-required field 172-1 means that an answer to the question 201-2 is required in the reply email 164-2. The answer data 410-1 answers the question 201-1 that is connected to the answer-required field 172-1, as pointed to by the pointer 415. Thus, by operation of the pointer 415 and the answer-required field 172-1, the answer data 410-1 is associated with or connected to the question 201-1. Hence, in the example of FIG. 5 the user of the recipient email address 260 does not need to edit the replied-to email 168-2 to answer the question 201-1; instead the user may answer the question 201-1 in the reply data 166-2 of the replied-to email 168-2, in the natural flow of the user's own email (in the reply data 166-2 as the answer data 410-1).

The recipient email controller 160 embeds or adds the answer 410-2 to the replied-to email 168-2 in the answer-required field 172-2, in response to data entry from a user at the recipient computer system 100. The answer 410-2 is a deferred answer indication, indicating that an answer to the question 201-2 will be supplied in another reply email at a later time, or subsequent to, the reply email 164-2.

In response to the send command 302, if the user has supplied the answers 410-1 (connected to the answer-required field 172-1 by the pointer 410) and 410-2 (connected to the answer-required field 172-2 by being in the answer-required field 172-2), the recipient email controller 160 sends the reply email 164-2 to the source (the source email address 250) of the replied-to email 168-1, which is the source of the source email 162. If the user has not supplied the answers 410-1 and 410-2 for the answer-required fields 172-1 and 172-2, respectively, the recipient email controller 160 blocks the sending of the reply email 164-2 (does not send the reply email 164-2) and presents the answer required message 305 to indicate that answers must be supplied to the questions 201-1 and 201-2 in order to send the reply email 164-2.

FIG. 5 depicts a block diagram of an example to-do list 170, according to an embodiment of the invention. The example to-do list 170 includes records 505 and 510, each of which includes a source email identifier 515, an answer-required field identifier 520, and a reply sent time field 525. The source email identifier 515 identifies a source email 162. The answer-required field identifier 520 identifies an answer-required field 172 in the source email 162, such as the answer-required field 172-1 or the answer-required field 172-2. The answer-required field 172 identified by the answer-required field identifier 520 received a deferred answer indication, indicating that the answer to the associated question will be sent in a later email than the reply email 164 that was sent to the source, which caused the record to be added to the to-do list 170. The reply sent time field 525 indicates the date and/or time that reply email 164 (which contained the answer-required field 172 identified by the answer-required field identifier 520) was sent to the source (the source email address 250) of the source email 162.

FIG. 6 depicts a flowchart of example processing for adding a answer-required field 172 to a source email 162, according to an embodiment of the invention. Control begins at block 600. Control then continues to block 605 where the source email controller 180 receives an add answer-required command 205 that identifies a question (e.g., the question 201-1 or 201-2) in the source email 162. Control then continues to block 610 where the source email controller 180 adds the answer-required field 172 to the source email 162 in response to the add answer-required command 205 that identified the question (e.g., the question 201-1 or 201-2) in the source email 162. Control then continues to block 615 where the source email controller 180 sends the source email 162 to the recipient email address 260. Control then continues to block 620 where the recipient email controller 160 receives the source email 162 for the recipient email address 260. Control then continues to block 699 where the logic of FIG. 6 returns.

FIG. 7 depicts a flowchart of example processing for adding a answer-required field 172 to a source email 162, according to an embodiment of the invention. Control begins at block 700. Control then continues to block 705 where the source email controller 180 searches the source email 162 for the question marks 202, which indicate a question, e.g. the questions 201-1 or 201-2. Control then continues to block 710 where the source email controller 180 determines whether any question marks 202 were found by the search of block 705, and if question marks 202 were found, the source email controller 180 adds an answer-required field 172 to the source email 162. In an embodiment, the source email controller 180 adds the answer-required field 172 following the found question mark 202. In another embodiment, the source email controller 180 adds the answer-required field 172 at any appropriate location and associates the answer-required field 172 with the found question or question mark, e.g., by adding a pointer associated with the question or question mark to the answer-required field 172, or by adding a pointer associated with the answer-required field 172 to the associated question or question mark.

Control then continues to block 715 where the source email controller 180 sends the source email 162 to the recipient email address 260. Control then continues to block 720 where the recipient email controller 160 receives the source email 162 for the recipient email address 260. Control then continues to block 799 where the logic of FIG. 7 returns.

Although FIG. 7 illustrates the source email controller 180 performing the processing of blocks 705 and 710 prior to sending the source email 162, in another embodiment, the recipient email controller 160 may perform the finding of the question marks 202 and the adding the answer-required field 172 to the source email 162 subsequent to receiving the source email 162.

FIG. 8 depicts a flowchart of example processing for a reply command, according to an embodiment of the invention. Control begins at block 800. Control then continues to block 805 where the recipient email controller 160 receives a reply command that specifies a source email 162 and a request to reply to the source email 162, and in response, the recipient email controller 160 creates a reply email 164 and copies or embeds the source email 162 as the replied-to email 168 in the reply email 164.

Control then continues to block 810 where the recipient email controller 160 adds or creates the reply data 166 in the reply email 164 and any answer data 310-1, 310-2, 410-1, or 410-2 in response to data entry via a user interface. The reply data 166 is separate from the replied-to email 168. In an embodiment, the recipient email controller 160 adds the answer data to the reply data 166 and a pointer 415 that is associated with the answer data to the reply data 166. The pointer 415 identifies the answer-required field 172 in the replied-to email 168. In another embodiment, the recipient email controller 160 adds or embeds the answer data to the answer-required field 172 in the replied-to email 168 or associates the answer data with the answer-required field 172 in the replied-to email 168.

Control then continues to block 815 where the recipient email controller 160 receives a send command 302 that specifies a reply email 164, which is a reply to a source email 162. Control then continues to block 820 where the recipient email controller 160 determines whether the source email 162 has a answer-required field 172.

If the determination at block 820 is true, then the source email 162 has a answer-required field 172, so control continues to block 825 where the recipient email controller 160 determines whether the reply email 164 includes answer data associated with the answer-required field 172. In an embodiment the recipient email controller 160 performs the determining of block 825 by determining whether the reply email 164 includes an answer embedded into the replied-to email 168, and the answer is associated with the answer-required field 172, e.g., embedded in the answer-required field 172. In another embodiment, the recipient email controller 160 performs the determining of block 825 by determining whether the reply email 164 includes a pointer 415, e.g., in the reply data 166-2 separate from the replied-to email 168-2, that identifies or points to the answer-required field 172-1 in the replied-to email 168-2 and whether the pointer 415 is associated with or connected to the answer data 410-1.

If the determination at block 825 is true, then the reply email 164 includes answer data associated with the answer-required field 172, so control continues to block 830 where the recipient email controller 160 decides whether the answer comprises a deferred answer indication that the question will be answered in another email after sending the reply email 164.

If the deciding at block 830 is true, then the answer indicates a deferred answer indication, indicating that the question will be answered in another email after, or subsequent to, the sending of the reply email 164, so control continues to block 835 where the recipient email controller 160 adds records to the to-do list 170 for any answer-required fields 172 in the reply email 164 that have answer data that indicates that the reply email 164 does not include an answer for that answer-required field 172, but that an answer will be provided via a later email, subsequent to the sending of the reply email 164. The recipient email controller 160 saves an identifier of the source email 162, an identifier of the answer-required field 172, and a reply sent time that the reply email 164 was sent to a record with fields 515, 520, and 525 in the to-do list 170.

Control then continues to block 840 where the recipient email controller 160 sends the reply email 164 to the source (the source email address 250) of the source email 162. Control then continues to block 899 where the logic of FIG. 8 returns.

If the determination at block 830 is false, then the answer does not indicate a deferred answer indication that the question will be answered after sending the reply email 164, so control continues to block 840 where the recipient email controller 160 sends the reply email 164 to the source email address 250, as previously described above. Then control continues to block 899 where the logic of FIG. 8 returns.

If the determination at block 825 is false, then the reply email 164 does not include answer data associated with the answer-required field 172, so control continues to block 845 where the recipient email controller 160 blocks or prevents the sending of the reply email 164. Control then continues to bock 899 where the logic of FIG. 8 returns.

If the determination at block 820 is false, then the source email 162 does not have an answer-required field 172, so control continues to block 840 where the recipient email controller 160 sends the reply email 164 to the source email address 250. Control then continues to block 899 where the logic of FIG. 8 returns.

FIG. 9 depicts a flowchart of example processing for displaying records from a to-do list 170, according to an embodiment of the invention. Control begins at block 900. Control then continues to block 905 where the recipient email controller 160 determines whether a time period has expired. If the determination at block 905 is true, then the time period has expired, so control then continues to block 905 where the recipient email controller 160 determines whether any records exist in the to-do list 170 that have an elapsed time since the reply sent time 525 (the difference between the current time and the reply sent time 525) that exceeds a threshold.

If the determination at block 910 is true, then a record in the to-do list 170 exists with an elapsed time since the reply sent time 525 that exceeds a threshold, so control continues to block 915 where the recipient email controller 160 presents a reminder that the answer is required, such as data (the source email identifier 515, the answer-required field identifier 520, and the reply sent time 525) from the records with elapsed times since the reply sent time 525 that exceed the threshold. Control then continues to block 920 where the recipient email controller 160 determines whether a reply email 164 has been sent (e.g., in response to the reminder) to the source email address 250 of the source email 162 that contains an answer to the question as required by the answer-required field 172.

If the determination at block 920 is true, then the answer required by the answer-required field 172 has been sent, so control continues to block 925 where the recipient email controller 160 removes the record for the source email 162 that was replied to from the to-do list 170. Control then returns to block 905, as previously described above.

If the determination at block 920 is false, then the answer required by the answer-required field 172 has not been sent, so control continues to block 905, as previously described above.

If the determination at block 910 is false, then no record in the to-do list 170 has an elapsed time since the reply sent time 525 that is greater than a threshold, so control returns to block 905, as previously described above.

If the determination at block 905 is false, then the time period has not expired, so control returns to block 905 where the recipient email controller 160 once again determines whether the time period has expired, as previously described above. In another embodiment, a software or hardware timer may raise an interrupt or send a message to the recipient email controller 160 upon expiration of the time period.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. In the previous description, numerous specific details were set forth to provide a thorough understanding of embodiments of the invention. But, the invention may be practiced without these specific details. In other instances, well-known circuits, structures, and techniques have not been shown in detail in order not to obscure the invention. Different instances of the word “embodiment” as used within this specification do not necessarily refer to the same embodiment, but they may.

Any data, data values, data structures, and names or identifiers of fields or data structures illustrated or described herein are examples only, and in other embodiments, different names, identifiers, amounts of data, data values, types of data, fields, numbers and types of fields, field names, data structure names, numbers and types of rows, records, entries, or organizations of data may be used. In addition, any data may be combined with logic, so that a separate data structure is not necessary. The previous detailed description is, therefore, not to be taken in a limiting sense, and the scope of the present invention is defined only by the appended claims.

What is claimed is:

1. A method comprising:
receiving a send command that specifies a reply email, wherein the reply email is a reply to a source email;
if the source email comprises an answer-required field, determining whether the reply email comprises an answer associated with the answer-required field;
if the reply email comprises the answer associated with the answer-required field, sending the reply email to a source of the source email; and
if the reply email does not comprise the answer associated with the answer-required field, blocking the sending of the reply email.

2. The method of claim 1, further comprising:
embedding the source email as a replied-to email in the reply email.

3. The method of claim 2, wherein the determining further comprises:
determining whether the reply email comprises a pointer that identifies the answer-required field in the replied-to email and whether the pointer is associated with the answer.

4. The method of claim 3, wherein the reply email comprises reply data that is separate from the replied-to email, and wherein the reply data comprises the answer and the pointer.

5. The method of claim 3, wherein the answer is embedded in the answer-required field in the replied-to email.

6. The method of claim 2, further comprising:
adding reply data to the reply email, wherein the reply data is separate from the replied-to email, and wherein the reply data comprises the answer and a pointer associated with the answer, wherein the pointer identifies the answer-required field in the replied-to email.

7. The method of claim 1, wherein the answer-required field is associated with a question in the source email.

8. The method of claim 7, further comprising:
deciding whether the answer comprises an indication that the question will be answered after the sending;
if the deciding is true, saving an identifier of the source email, an identifier of the answer-required field, and a reply sent time that the reply email was sent to a to-do list; and
if an elapsed time since the sent time exceeds a threshold, presenting a reminder that the answer is required.

9. A signal-bearing medium encoded with instructions, wherein the instructions when executed comprise:
embedding a source email as a replied-to email in a reply email;
receiving a send command that specifies the reply email, wherein the reply email is a reply to the source email;
if the replied-to email comprises an answer-required field, determining whether the reply email comprises an answer associated with the answer-required field, wherein the answer-required field is associated with a question in the source email;
if the reply email comprises the answer associated with the answer-required field, sending the reply email to a source of the source email; and
if the reply email does not comprise the answer associated with the answer-required field, blocking the sending of the reply email.

10. The signal-bearing medium of claim 9, wherein the determining further comprises:
determining whether the reply email comprises a pointer that identifies the answer-required field and whether the pointer is associated with the answer.

11. The signal-bearing medium of claim 10, wherein the reply email comprises reply data that is separate from the replied-to email, and wherein the reply data comprises the answer.

12. The signal-bearing medium of claim 10, wherein the answer is embedded in the replied-to email.

13. The signal-bearing medium of claim 9, further comprising:
adding reply data to the reply email, wherein the reply data is separate from the replied-to email, and wherein the reply data comprises the answer and a pointer associated with the answer, wherein the pointer identifies the answer-required field in the replied-to email.

14. The signal-bearing medium of claim 9, further comprising:
adding the answer to the answer-required field in the replied-to email.

15. A method for configuring a computer, comprising:
configuring the computer to copy a source email to a replied-to email embedded in a reply email;
configuring the computer to receive a send command that specifies the reply email, wherein the reply email is a reply to the source email;
configuring the computer to, if the source email comprises an answer-required field, determine whether the reply email comprises an answer associated with the answer-required field, wherein the answer-required field is associated with a question in the source email;
configuring the computer to, if the reply email comprises the answer associated with the answer-required field, send the reply email to a source of the source email;
configuring the computer to, if the reply email does not comprise the answer associated with the answer-required field, block the sending of the reply email; and
configuring the computer to decide whether the answer comprises an indication that the question will be answered after the sending.

16. The method of claim 15, wherein the configuring the computer to determine further comprises:
configuring the computer to determine whether the reply email comprises a pointer that identifies the answer-required field and whether the pointer is associated with the answer.

17. The method of claim 15, further comprising:
configuring the computer to, if the deciding is true, save an identifier of the source email, an identifier of the answer-required field, and a reply sent time that the reply email was sent to a to-do list; and
configuring the computer to, if an elapsed time since the sent time exceeds a threshold, present a reminder that the answer is required.

18. The method of claim 15, wherein the source of the source email added the answer-required field to the source email in response to a command that identified the question in the source email.

19. The method of claim 15, wherein the source of the source email added the answer-required field to the source email in response to a search of the source email that found a question mark in the source email.

20. The method of claim 15, further comprising:
configuring the computer to search the source email for a question mark; and
configuring the computer to, if the searching finds the question mark, add the answer-required field to the source email.
